(19) United States
(12) Patent Application Publication
(10) Pub. No.: US 2018/0064045 A1
(43) Pub. Date: Mar. 8, 2018

(54) METHOD AND SYSTEM FOR GROWING PLANTS WITH A RECTANGULAR ROOT ZONE

(71) Applicant: Hollandia Produce, L.P., Carpinteria, CA (US)

(72) Inventor: Petrus Overgaag, Carpinteria, CA (US)

(21) Appl. No.: 15/257,839

(22) Filed: Sep. 6, 2016

(51) Int. Cl. A01G 31/02; A01G 1/00; A01G 31/00; A01G 31/04; A01G 7/04; A01G 29/00; B65B 25/02; B65D 1/36; B65D 43/16; B65D 25/20

(52) U.S. Cl. CPC A01G 31/02; A01G 1/001; A01G 31/001; A01G 31/042; A01G 7/045; A01G 2031/005; B65B 25/02; B65D 1/36; B65D 43/16; B65D 25/205; A01G 29/00

(57) ABSTRACT

An apparatus and method for growing and packaging of live plants. The method involves placing a tray with a plurality of strip grooves on a conveyor system and putting growing media into the strip grooves. Plant seeds are then placed substantially in a single row longitudinally on the growing media and nutrients are added. The tray is then placed in a greenhouse until the seeds in each strip mature into a live plant with leaves and a root ball. The root balls are separated from the strip grooves and the live plant is placed in a container that is configured for display and for continued growth. The container is clamshell with a compartment for the leaves and a compartment for the root ball. The root ball compartment securely clamps the root ball and prevents it from sliding within the container. The root ball compartment includes a nutrient compartment.

### BACKGROUND OF THE INVENTION

### Field of the Invention

Embodiments of the invention relates to the field of hydroponics and container growing. More specifically, the invention relates to an apparatus and method for growing and packaging of live plants.

### Description of the Related Art

Normally, hydroponic and container growing methods involve growing of multiple plants in square or round containers thereby forming root balls of similar shape. The problem with grouping more than one plant in a square or round root balls arrangement is that light does not reach all the plants evenly resulting in some yellow leaves. This becomes more pronounced when packaged and in store displays.

Also, the advantage of hydroponic and container growing and packaging of live plants is that one can have fresh and live vegetables up to the time of use. However, since these plants still have their roots and root balls when the package is opened in the kitchen, one would have to separate the root balls from the leaves. This process of separating the root balls from the leaves would sometimes leave unpalatable mess around the food. In some cases, parts of the root balls may even mix with the leaves.

To overcome the problems and limitations described above there is a need for a packaging and growing method that assures that all the plants receive approximately the same amount of light and alleviates the unpalatable mess when separating leaves from the root balls.

### BRIEF SUMMARY OF THE INVENTION

One or more embodiments of the invention are directed an apparatus and method for growing and packaging of live plants. The invention comprises the process of placing a tray with a plurality of strip grooves on a conveyor system and putting growing media into the strip grooves. The strips are rectangular and approximately one inch in width.

Plant seeds are then placed substantially in a single row longitudinally on the growing media followed by the addition of nutrients. Note that nutrients can also be added prior to or concurrent with placement of the plant seeds on the growing media.

The tray is then placed in a greenhouse until the seeds in each strip mature into a live plant with leaves and a root ball. The root balls are separated from the strip grooves and the live plant is placed in a container that is configured for display and to sustain the live plant.

The container is a thermoformed thermoplastic clamshell with a compartment for the leaves and a compartment for the root ball. The root ball compartment clamps and retains the root ball and prevents it from sliding within the container. The root ball compartment has a nutrient compartment connected thereto.

The leaf compartment comprises a bottom wall with an upwardly extending full sidewall leaving an open end with an upwardly extending partial sidewall that terminates into a ridge. The full sidewall terminates in an outwardly extending peripheral lip and is coupled to a support post at each open end. A skirt extends downwardly from the lip, and a generally horizontal peripheral flange extends outwardly from the skirt.

In one or more embodiments, a first lid is pivotally coupled to one side of the leaf compartment at the horizontal peripheral flange. The first lid is configured to snap fit and lock to the leaf compartment using one or more tongue-and-groove type locks.

In one or more embodiments, the root ball compartment has a bottom wall that is elevated approximately one-third the height of the leaf compartment. The bottom wall extends outwardly from the bottom of ridge, thereby coupling the leaf compartment with the root ball compartment. The ridge is configured prevent sliding of the root ball of a live plant and is configured such that the blade of a knife could be run down its edge on the leaf compartment side to cut and separate the leaves from the roots. The bottom wall of the root ball compartment, on which the root ball of the live plant sits, is configured as a tabletop to hold the root ball and includes a hole to which a nutrient holding container is connected. The sidewall of the root ball compartment extends upwardly from its bottom wall and terminates in an outwardly extending peripheral lip. A skirt extends downwardly from the lip, and a generally horizontal peripheral flange extends outwardly from the skirt. The sidewall couples to the open end of leaf compartment at a support post on either side thereby forming one contiguous base unit.

A second lid is pivotally coupled through a hinge to the peripheral flange of the root ball compartment. The second lid is configured such that, in combination with the bottom wall of the root ball compartment, it acts like a clamp to retain the root ball of a live plant. The second lid has a clamping groove with a flat bottom wall lowered approximately one-third the height from the top of the leaf compartment to define a rectangular channel within the root ball compartment for securing the root ball of a live plant. The second lid includes a plurality of tongue tabs that secures to grooves on the support posts.

The first lid further comprises a tab that is configured to overlay the clamping groove in the root ball compartment when both the first lid and the second lid are closed. The tab is used to open the first lid by pulling up.

### BRIEF DESCRIPTION OF THE DRAWINGS

The above and other aspects, features and advantages of the invention will be more apparent from the following more particular description thereof, presented in conjunction with the following drawings wherein:

FIG. 1 is an illustration of an isometric view of a live plant packaging container in a closed position in accordance with one or more embodiments of the present invention.

FIG. 2 is an illustration of a left side plan view of the live plant packaging container in a closed position in accordance with one or more embodiments of the present invention.

FIG. 3 is an illustration of a top plan view of the live plant packaging container in a closed position in accordance with one or more embodiments of the present invention.

FIG. 4 is an illustration of an isometric view of the live plant packaging container with the covers opened in accordance with one or more embodiments of the present invention.

FIG. 5 is an illustration of a left side plan view of the live plant packaging container with the covers opened in accordance with one or more embodiments of the present invention.

FIG. 6 is an illustration of a top plan view of the live plant packaging container with the covers opened in accordance with one or more embodiments of the present invention.

FIG. 7 is an illustration of a front plan view of the live plant packaging container with the covers closed in accordance with one or more embodiments of the present invention.

FIG. 8 is an illustration of an isometric view of the live plant packaging container with the leaf compartment and the root ball compartment lids in a partially opened position in accordance with one or more embodiments of the present invention.

FIG. 9 is an illustration of an isometric view of the live plant packaging container with the leaf compartment lid in a partially opened position and the root ball compartment lid in a closed position in accordance with one or more embodiments of the present invention.

FIG. 10 is a flowchart illustrating the hydroponics growing process for strip root plant in accordance with one or more embodiments of the present invention.

FIG. 11 is an illustration of the strip trays with growing media and plants in accordance with one or more embodiments of the present invention.

FIGS. 12A and B are illustrations of a harvested strip root plant in accordance with one or more embodiments of the present invention.

### DETAILED DESCRIPTION

The present invention comprising an apparatus and method for growing and packaging of live plants will now be described. In the following exemplary description numerous specific details are set forth in order to provide a more thorough understanding of embodiments of the invention. It will be apparent, however, to an artisan of ordinary skill that the present invention may be practiced without incorporating all aspects of the specific details described herein. Furthermore, although steps or processes are set forth in an exemplary order to provide an understanding of one or more systems and methods, the exemplary order is not meant to be limiting. One of ordinary skill in the art would recognize that the steps or processes may be performed in a different order, and that one or more steps or processes may be performed simultaneously or in multiple process flows without departing from the spirit or the scope of the invention. In other instances, specific features, quantities, or measurements well known to those of ordinary skill in the art have not been described in detail so as not to obscure the invention. It should be noted that although examples of the invention are set forth herein, the claims, and the full scope of any equivalents, are what define the metes and bounds of the invention.

For a better understanding of the disclosed embodiment, its operating advantages, and the specified object attained by its uses, reference should be made to the accompanying drawings and descriptive matter in which there are illustrated exemplary disclosed embodiments. The disclosed embodiments are not intended to be limited to the specific forms set forth herein. It is understood that various omissions and substitutions of equivalents are contemplated as circumstances may suggest or render expedient, but these are intended to cover the application or implementation.

The term “first”, “second” and the like, herein do not denote any order, quantity or importance, but rather are used to distinguish one element from another, and the terms “a” and “an” herein do not denote a limitation of quantity, but rather denote the presence of at least one of the referenced item.

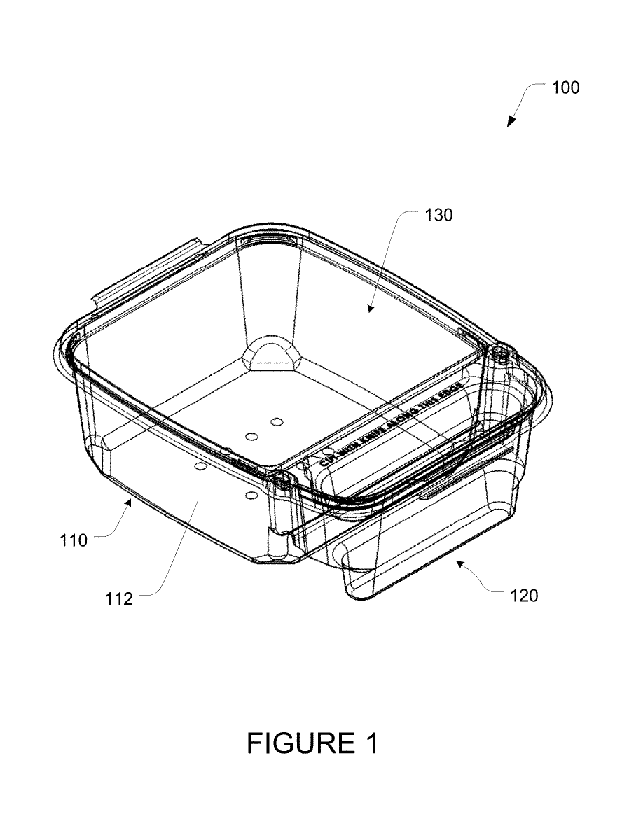

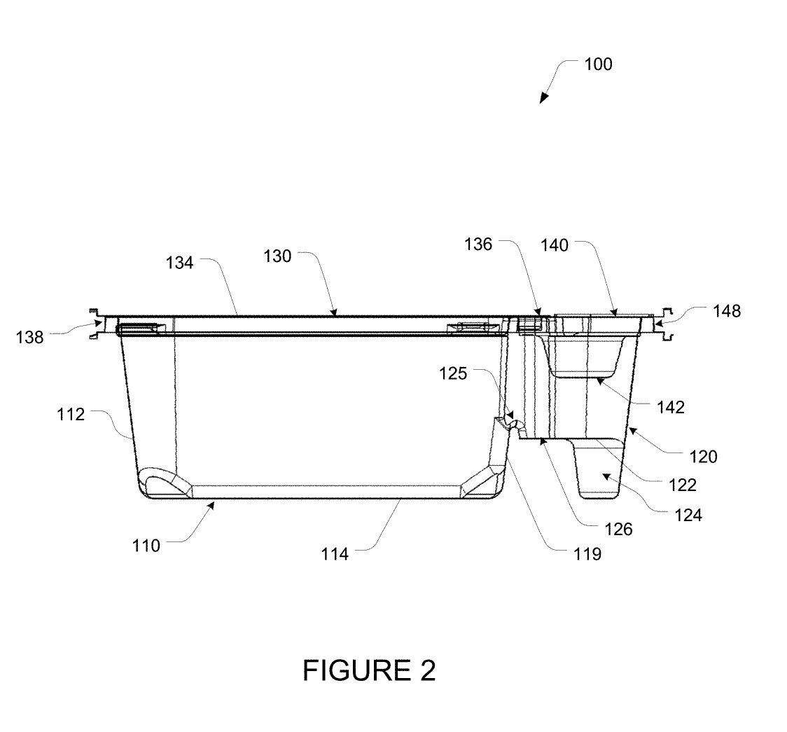

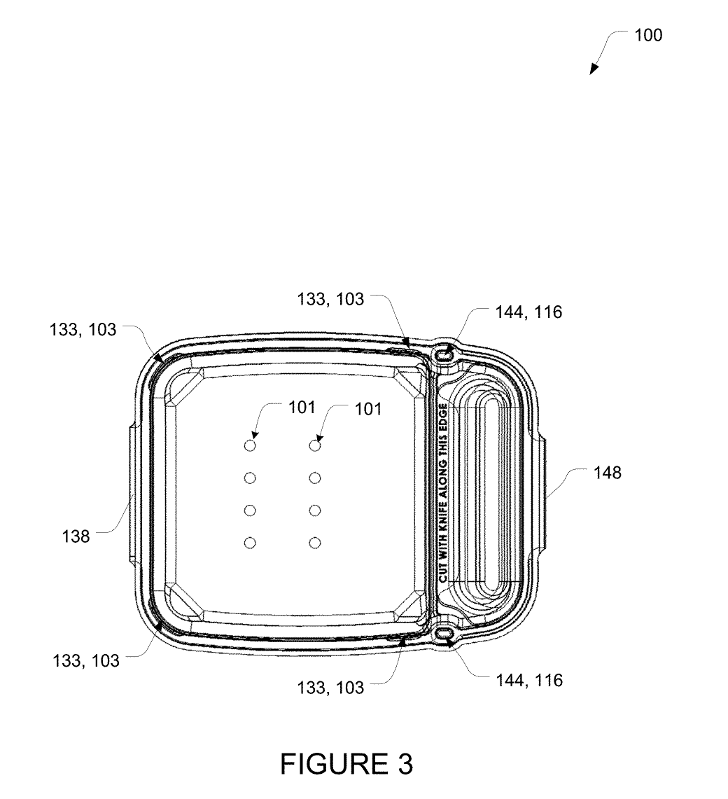

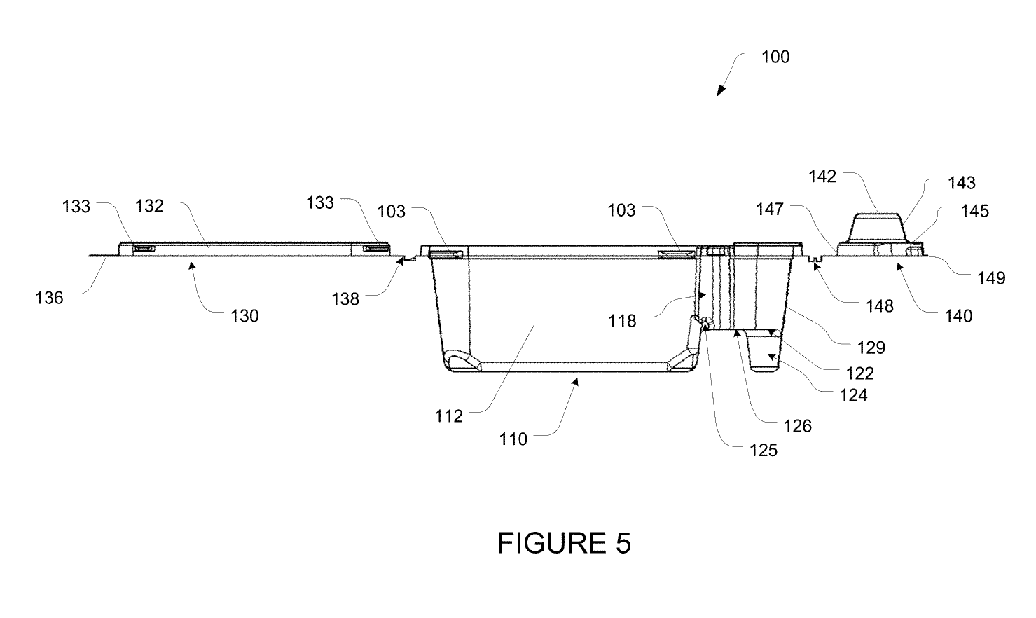

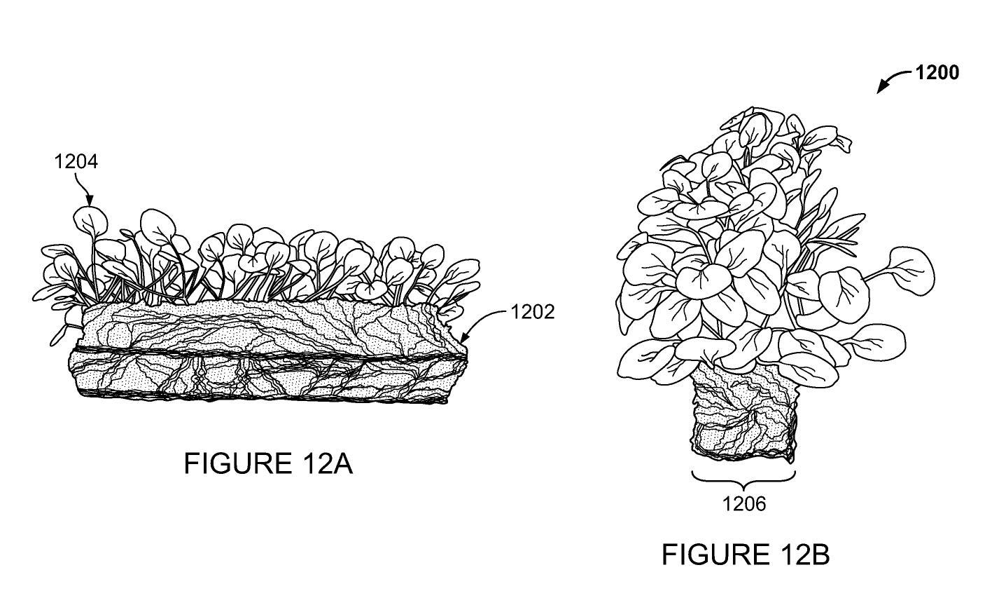

One or more embodiments of the present invention will now be described with references to FIGS. 1-12.

### Packaging Container:

Referring more particularly to FIGS. 1-9, a container 100 is presented. The container 100 is preferably thermoformed thermoplastic clamshell which is molded from a single sheet of thermoplastic material. Container 100 comprises a base section with a leaf (or first) compartment 110 and a root ball (or second) compartment 120. In one or more embodiments, container 100 further comprises a first lid 130, which is connected to the leaf compartment 110, and pivots about a hinge 138 between a position which covers the leaf compartment 110 and one which uncovers the leaf compartment 110. Container 100 further comprises second lid 140, which is connected to the root ball compartment 120, and pivots about a hinge 148 between a position which covers the root ball compartment 120 and one which uncovers the root ball compartment 120. Those of skill in the art would appreciate that although first lid 130 and second lid 140 are illustrated to be pivotally engaged to leaf compartment 110 and root ball compartment 120, respectively, other configurations are contemplated. For instance, either or both first lid 130 and second lid 140 may be configured as separate parts that are not integrally formed or connected with the base section when open.

In one or more embodiments, the sheet of thermoplastic material from which the container 100 is formed is preferably coextruded of transparent material in the regions defining the first lid 130. The regions defining the leaf compartment 110, the root ball compartment 120 and second lid 140 may generally comprise opaque or semi-opaque material. Those of skill in the art would appreciate that embodiments with the entire container 100 comprising transparent material is also contemplated and that the choice of transparency depends on desire for ornamentation and aesthetic.

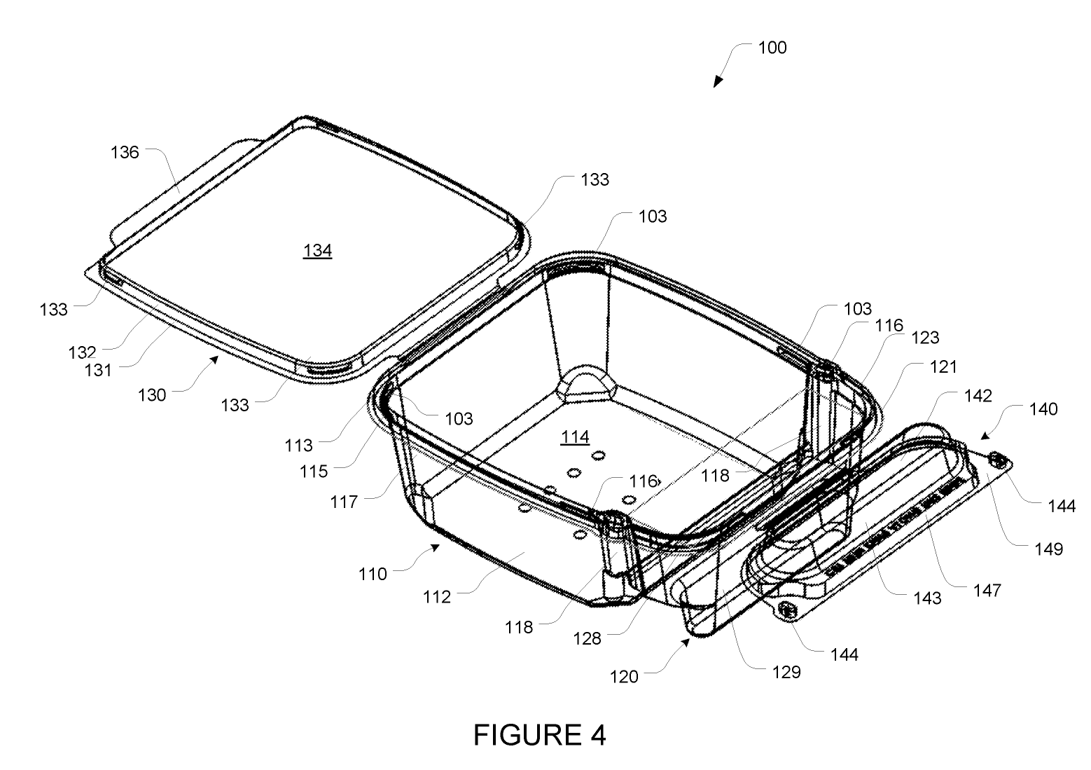

As better seen in FIG. 4, the leaf compartment 110 has a bottom wall 114 from which a sidewall 112 extends upwardly therefrom, leaving a substantially open end at the connection with root ball compartment 120, and terminating in an outwardly extending peripheral lip 113. Sidewall 112 is coupled to a support post 118 at each open end. A skirt 115 extends downwardly from the lip 113, and a generally horizontal peripheral flange 117 extends outwardly from the skirt. In one or more embodiments, hinge 138 is coupled to peripheral flange 117 on leaf compartment 110 and flange 131 on first lid 130. In one or more embodiments, the height of the leaf compartment is approximately three inches. Of course, other heights are contemplated thus the chosen height for the container would depend on the application.

Each side of the open end of leaf compartment 110 is coupled to a support structure 118. The general outline of the leaf compartment 110 and the sidewall 112 is preferably configured for stiffness. For instance, the general outline may be other than strictly rectangular, e.g. some form of a closed curved shape. The peripheral flange 117 extends outwardly from the skirt 115 a uniform amount for most of the periphery around leaf compartment 110.

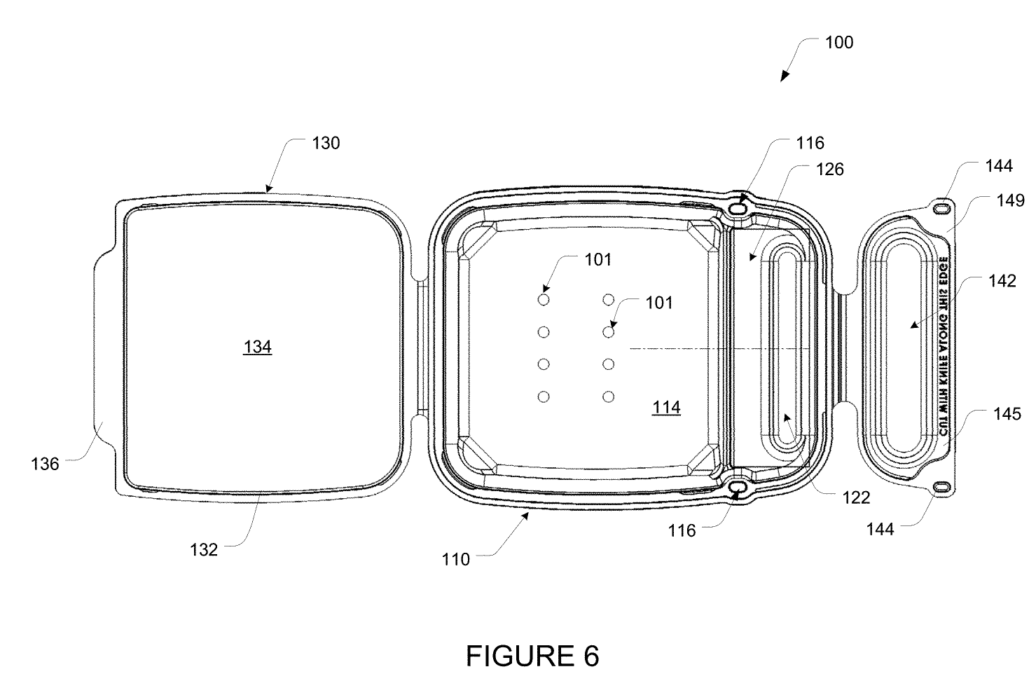

In one or more embodiments, each support post 118 runs from top of sidewall 112 and extends downwardly to approximately two-thirds the height of sidewall 112 and includes a groove 116 at the top. The leaf compartment 110 further comprises a sidewall 119 on the open side, extending upwardly from bottom wall 114 and terminating in an outwardly extending ridge 125 at the base of support structure 118. Sidewall 119 extends to approximately one-third to midway the height of sidewall 112 and is coupled to the bottom section of sidewall 112 to complete the space comprising the leaf compartment 110. As better illustrated in FIG. 6, ridge 125 is configured such that a knife's blade could be run down its edge on the leaf compartment side to cut and separate the leaves from the roots. As further discussed below, the knife is used to cut and separate the root ball 1202 from the leaves 1204, with second lid 140 in a closed position.

Since the leaf compartment 110 is configured to contain the leaves of a live plant, the bottom wall 114 comprises one or more holes 101 for ventilation and drainage. Those of skill in the art would appreciate that the number and placement of the ventilation and drainage holes 101 in leaf compartment 110 could be modified from that illustrated without deviating from the invention. For instance, embodiments without ventilation/drain holes are also contemplated, and embodiments with the ventilation/drain holes on the sidewall 112 or on the top wall 134 of the first lid 130 are also contemplated. In an exemplary usage, the ventilation/drain holes 101 may be covered with a label that can be peeled back so that the leaves can be rinsed in the package.

In one or more embodiments, the first lid 130 has a bottom wall 134 from which a sidewall 132 extends upwardly therefrom. The sidewall 132 terminates in an outwardly extending peripheral and horizontal flange 131. The general outline of sidewall 132 is such that when first lid 130 is pressed down on the top of leaf compartment 110 it is retained in the closed position in a snap fit with the peripheral flange 131 extending over lip 113 of leaf compartment 110.

First lid 130 further comprises a tab 136 which is configured to partially overlay second lid 140, when closed, and serve as a handle for separating first lid 130 from leaf compartment 110. First lid 130 further comprises one or more tongue tabs 133 located on the periphery of sidewall 132. As illustrated, there is preferably one tongue tab 133 at each corner of first lid 130.

In one or more embodiments, leaf compartment 110 further comprises one or more grooves 103 for securing the first lid 130 to the container leaf compartment body 110 using tongue-and-groove lock components 133 and 103. Thus, as illustrated, for each tongue tab 133 on first lid 130, there is a corresponding groove 103 in leaf compartment 110. Those of skill in the art would appreciate that other configurations for locking the first lid to leaf compartment 110 are contemplated. For instance, the tongue-and-groove lock components 133 and 103 may vary and may be switched such that the tongue is on the leaf compartment body 110 while the groove is on the first lid 130.

In one or more embodiments, root ball compartment 120 comprises a bottom wall 126 that extends outwardly from the bottom of ridge 125, thereby coupling the leaf compartment 110 with the root ball compartment 120. The bottom wall 126 comprises a first section and a second section. The first section is closest to the open end of leaf compartment, i.e. the end that is closest to ridge 125, and is configured as a tabletop to hold the root ball 1202 of a live plant 1200. The second section, which is the end farthest from ridge 125, includes a hole 122 abutting sidewall 129. Sidewall 129 of root ball compartment 120 extends upwardly from bottom wall 126, and terminates in an outwardly extending peripheral lip 123. A skirt 128 extends downwardly from the lip 123, and a generally horizontal peripheral flange 121 extends outwardly from the skirt 128. Sidewall 129 couples to the open end of leaf compartment 110 at support post 118 thereby forming one contiguous base unit. In one or more embodiments, hinge 148 is coupled to peripheral flange 121 on root ball compartment 120 and flange 149 on second lid 140.

In one or more embodiments, flange 117 and flange 121 are connected at support posts 118 thereby forming a single unit that runs the entire periphery of the base unit. As discussed above, because the root ball compartment 120 is configured for containment of the roots of a live plant 1200, the bottom wall 126 serves to hold the root ball 1202 of the live plant while ridge 125 provides horizontal support and restricts sliding of the root ball.

Root ball compartment 120 further comprises a nutrient holding section 124 coupled to the bottom wall 126 at hole 122. Nutrient holding section 124 is configured as a bucket that extends downwardly from the bottom wall 126 to approximately the same plane as the bottom wall 114 of leaf compartment 110.

In one or more embodiments, second lid 140 comprises a bottom wall 142 from which a sidewall 143 extends upwardly therefrom, and terminating in an outwardly extending peripheral and horizontal section 145. A skirt 147 extends upwardly from the horizontal section 145, and a generally horizontal peripheral flange 149 extends outwardly from the skirt 147. The general outline of skirt 147 is such that when second lid 140 is pressed down on the top of root ball compartment 120 it is retained in the closed position in a snug fit with its peripheral flange 149 extending over lip 123 of root ball compartment 120. Thus, the shape of the periphery of skirt 147 is configured to approximate the shape of the inside top lip of root ball compartment 120. The sheet of thermoplastic material from which the second lid 140 is formed is preferably coextruded of transparent material in the regions defining the bottom wall 142 to provide a window for viewing the root ball.

As illustrated, second lid 140 further comprises one or more tongue tabs 144 located on the inside top corners of flange 149 for securing the second lid 140 to the container root ball compartment body 120 using tongue-and-groove lock components 144 and 116. Thus, there is a corresponding tongue tab 144 on lid 140 for a groove 116 in support structure 118. Those of skill in the art would appreciate that other configurations for locking the second lid 140 to root ball compartment 120 are contemplated. For instance, the tongue-and-groove lock components 144 and 116 may vary and may be switched such that the tongue is on the root ball compartment body 120 while the groove is on the second lid 140.

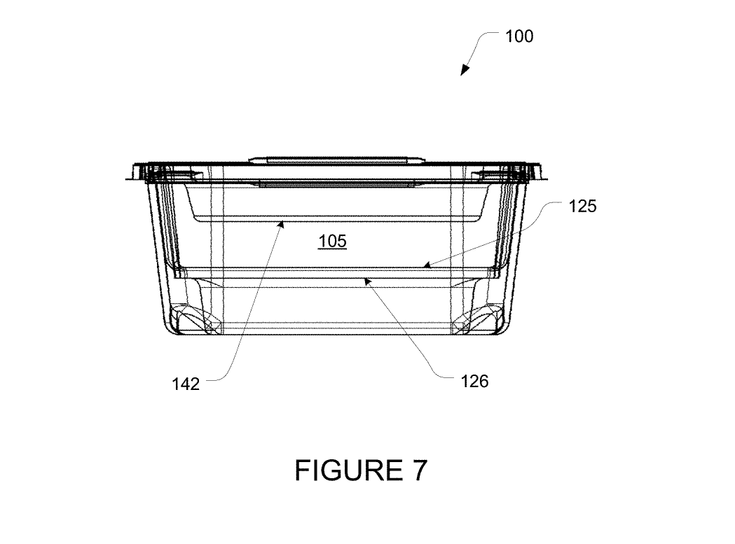

Bottom wall 142 is configured to be approximately one-third of the height of the leaf compartment down from the top of root ball compartment 120 and acts together with the bottom wall 142 to clamp and retain the root ball 1202 of live plant 1200. As illustrated in FIG. 7, when the second lid 140 is closed, the bottom wall 142 of the second lid 140 and the bottom wall 126 of the root ball compartment 120 together form opposite sides of a rectangular channel 105 for housing the root ball 1202 of the live plant 1200. The height of channel 105 is configured to be approximately the width 1206 of root ball 1202. Preferably, the channel 105 snugly secures the root ball in place by the second lid clamping the root ball down to the bottom wall 142.

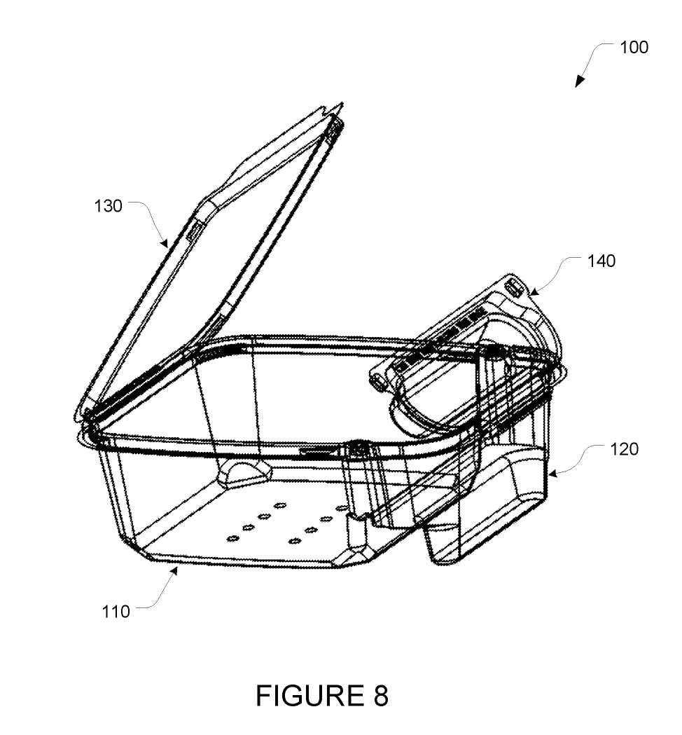

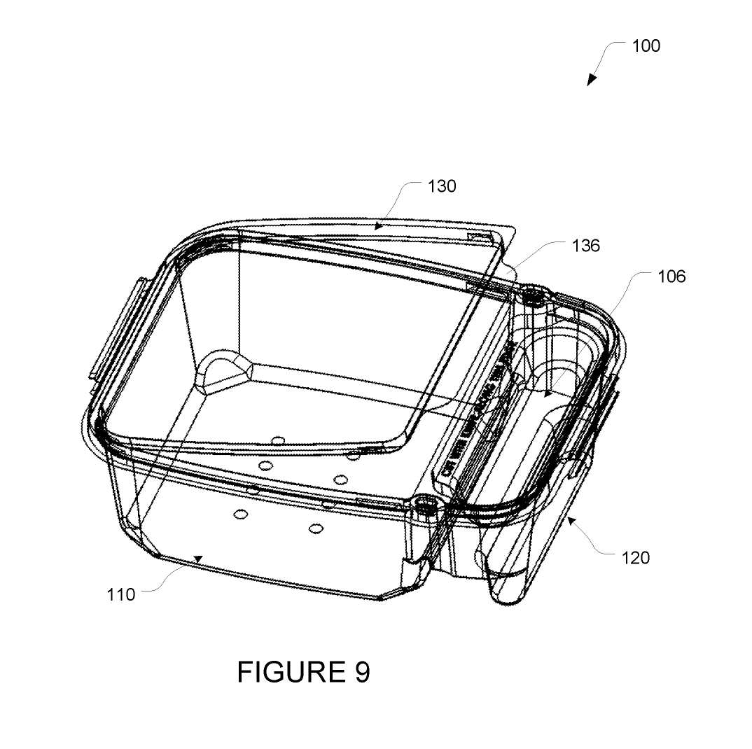

As illustrated in FIGS. 8 and 9, the closing sequence for the first and second lids of container 100 is such that second lid 140 is closed first and locked into place with tongue and groove components 144 and 116, followed by first lid 130, with tab 136 partially overlying the deep and wide clamping groove 106 on second lid 140. The deep and wide clamping groove 106 is formed by the flat bottom wall 142, sidewall 143 and skirt 147 on the second lid 140. The space identified by clamping groove 106 is configured to facilitate a user grabbing tab 136 in order to pull open first lid 130. For example, with a live plant 1200 in the container 100, the first lid 130 may be pulled open by the tab 136, and then to separate the root ball 1202 from the leaves 1204, the blade of a knife can be run across the length of the ridge 125. By cutting the root ball while the second lid 140 is closed, debris from the root ball is contained in root ball compartment 120.

### Strip Growing:

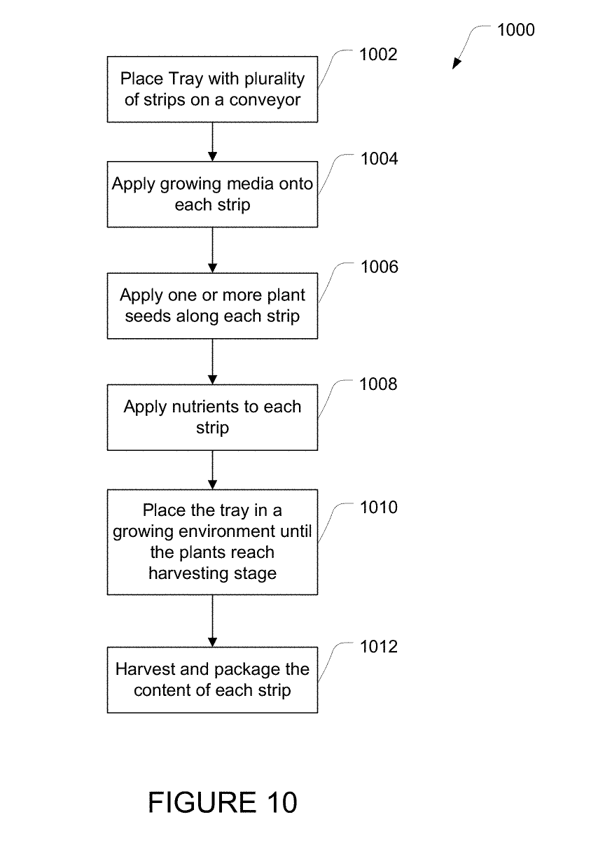

Strip growing of live plants of the present invention provides an added advantage that the leaves are exposed to substantially the same amount of light, e.g. sunlight, artificial light, etc., thus reducing incidences of yellow leaves that are prevalent in current growing and distribution methods for live vegetables such as butter lettuce, upland cress, and other greens. The strip growing process described herein results in better vegetable yield per square foot of planting. One or more embodiments of the strip growing process is illustrated using FIGS. 10-12.

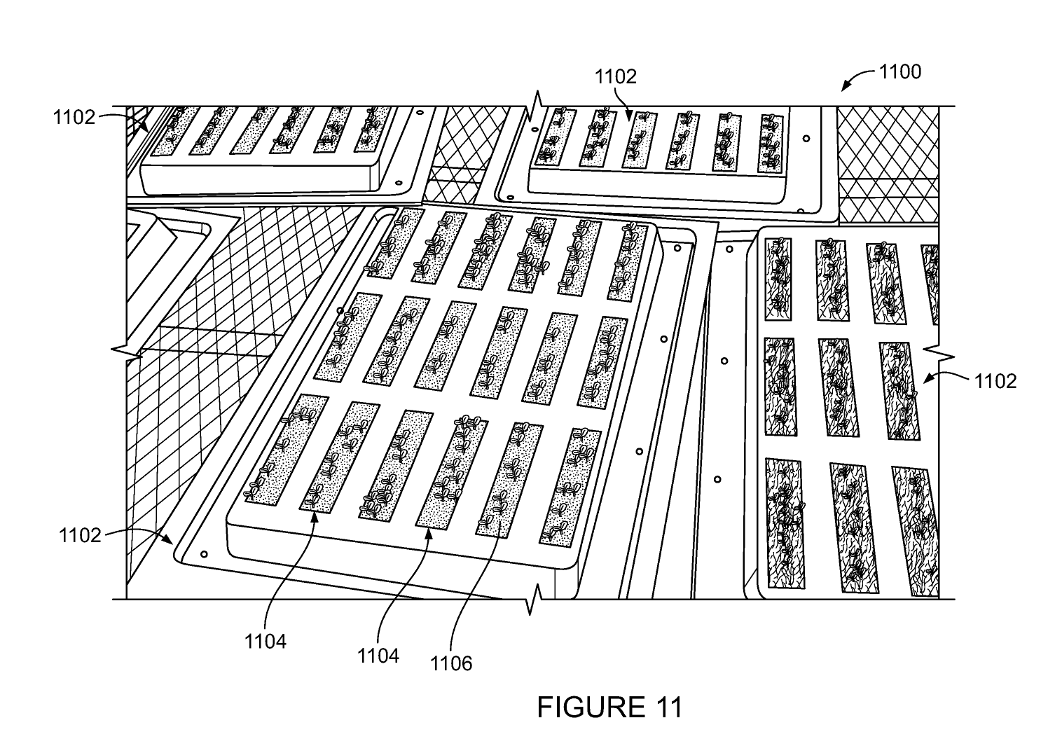

As illustrated in FIG. 10, the strip growing process begins at station 1002 by placing one or more trays with strip grooves on a conveyor belt or similar system. Trays 1102 with strip grooves, e.g. 1104, are illustrated in FIG. 11. Each strip is approximately 1.0 inch in width and is preferably between about 0.5 inches to about 1.5 inches in width. The length of the strip is preferably between 3.0 inches and 9.0 inches. One of skill in the art would appreciate that narrower or wider width and/or longer length strips are contemplated.

As the conveyor moves the tray 1102 to a next station 1004, growing media, e.g. 1106, is applied into the strip grooves 1104. Examples of growing media 1106 for hydroponic and container growing include coco fiber, rock wool fiber, Peat Moss, etc.

At station 1006, plant seeds are applied in substantially a single row along the longitudinal axis or randomly sprinkled on the surface of the growing media 1106 in strip groove 1104. At station 1008, nutrients are applied to the growing media in each strip groove; and at station 1010, each tray 1102 is placed in a growing environment until the plants, e.g. 1106, reach harvesting stage. A typical growing environment for hydroponic and container grown plants is a greenhouse, shade house and outdoor.

After the plants reach harvesting stage, at station 1012, each plant is harvested, e.g. 1200, and packaged in container, e.g. 100, for distribution. As discussed above, packaging with container 100 comprises placing the plant with its root ball entirely in the root ball compartment 120 and the leaves in the leaf compartment 110. Container 100 may include additional nutrients in nutrient holding section 124 to keep the plant 1200 living until ready for consumption, typically a few days or weeks. Those of skill in the art would appreciate that other type packaging containers are contemplated so long as the container is suitable for display and to provide nutrient and light to sustain the live plant. For instance, the container could be a bag specially configured for such purposes.

While the invention herein disclosed has been described by means of specific embodiments and applications thereof, numerous modifications and variations could be made thereto by those skilled in the art without departing from the scope of the invention set forth in the claims.

What is claimed is:

1. A method for growing and packaging of live plants comprising:
placing a tray on a conveyor system, wherein the tray comprises a plurality of strip grooves;
applying growing media to one or more of said plurality of strip grooves;
applying a plurality of plant seeds in substantially a single row longitudinally on the growing media;
applying plant nutrient to each of said plurality of strip grooves containing the growing media;
placing the tray in a greenhouse until the seeds in each strip mature into a live plant comprising leaves and a root ball; and
removing each root ball from the one or more of the plurality of strip grooves and placing the live plant in a container that is configured for display and sustainment of the live plant, wherein the container is further configured to facilitate using a knife to cut and separate the root ball from the leaves.

2. The method of claim 1, wherein the container comprises:
a base unit with a first compartment for the leaves and a second compartment for the root ball, wherein the first compartment comprises a first bottom wall with an upwardly extending first sidewall leaving a partially open end with an upwardly extending partial sidewall that terminates into a ridge, wherein the second compartment is connected to the partially open end and comprises a second bottom wall coupled to and beginning at said ridge with an upwardly extending second sidewall, and wherein said first sidewall of said first compartment and said second sidewall of said second compartment are coupled together at a support post at each end;
a first lid pivotally coupled to top of said first compartment and configured to snap fit to said first compartment; and
a second lid pivotally coupled to top of said second compartment and configured to snap fit to said second compartment, wherein said second lid comprises a clamping groove with a flat bottom wall lowered to create a rectangular channel such that the second lid clamps the root ball to the second bottom wall inside the root ball compartment.

3. The method of claim 2, wherein the second bottom wall includes a hole with a nutrient holding compartment attached thereto.

4. The method of claim 2, wherein the first bottom wall includes one or more drain holes.

5. The method of claim 4, wherein the one or more drain holes are covered with a label that can be peeled back to rinse the leaves.

6. The method of claim 2, wherein the ridge is configured such that a knife's blade could be run down its edge on the leaf compartment side to cut and separate the leaves from the roots.

7. The method of claim 1, wherein the growing media comprises peat moss.

8. The method of claim 1, wherein the growing media comprises coco fiber.

9. The method of claim 1, wherein the growing media comprises rock wool fiber.

10. The method of claim 1, wherein each of said plurality of strip grooves is rectangular with a width of approximately one inch.

11. A method for growing and packaging of live plants comprising:
placing a tray on a conveyor system, wherein the tray comprises a plurality of strip grooves;
applying growing media to one or more of said plurality of strip grooves;
applying a plurality of plant seeds in substantially a single row longitudinally on the growing media;
applying plant nutrient to each of said plurality of strip grooves containing the growing media;
placing the tray in a greenhouse until the seeds in each strip mature into a live plant comprising leaves and a root ball; and
removing each root ball from the one or more of the plurality of strip grooves and placing the live plant in a container, wherein the container comprises a first compartment for the leaves configured to expose the leaves to substantially the same amount of light and a second compartment to securely hold and isolate the root ball.

12. The method of claim 11, wherein the second compartment further comprises a nutrient holding compartment attached thereto.

13. The method of claim 11, wherein the first compartment includes one or more drain holes.

14. The method of claim 13, wherein the one or more drain holes are covered with a label that can be peeled back to rinse the leaves.

15. A method for growing and packaging of live plants comprising:
placing a tray on a conveyor system, wherein the tray comprises a plurality of strip grooves;
applying growing media to one or more of said plurality of strip grooves;
applying a plurality of plant seeds in substantially a single row longitudinally on the growing media;
applying plant nutrient to each of said plurality of strip grooves containing the growing media;
placing the tray in a greenhouse until the seeds in each strip mature into a live plant comprising leaves and a root ball; and
removing each root ball from the one or more of the plurality of strip grooves and placing the live plant in a container that is configured for display and sustainment of the live plant.

16. The method of claim 15, wherein said sustainment comprises providing nutrient and light to the live plant.
